(19) United States
(12) Patent Application Publication
(10) Pub. No.: US 2006/0062418 A1
(43) Pub. Date: Mar. 23, 2006

(54) Printed circuit board for speaker and speaker with the same, and method of manufacturing the same

(75) Inventor: Kazuo Hashiba, Tendo (JP)

Correspondence Address: SUGHRUE MION, PLLC, 2100 PENNSYLVANIA AVENUE, N.W., SUITE 800, WASHINGTON, DC, 20037, US

(73) Assignees: PIONEER CORPORATION; TOHOKU PIONEER CORPORATION

(21) Appl. No.: 11/199,197

(22) Filed: Aug. 9, 2005

(30) Foreign Application Priority Data
Aug. 26, 2004 (JP) 2004-246241

(51) Int. Cl. H04R 1/02

(52) U.S. Cl. 381/386

(57) ABSTRACT

For providing a printed circuit board, which can be miniaturized, and a speaker with the printed circuit board, and a method of manufacturing the printed circuit board, the speaker includes a speaker unit and a printed circuit board for supplying an audio current to the speaker unit. The printed circuit board has an insulation base board and a conductive circuit pattern formed on the base board. The conductive circuit pattern is formed of a base metal laminated on the base board and plated layers stacked on the base metal. An outer edge of the base board and an outer edge of the base metal overlap on each other. The outer edge of the base metal is covered by the plated layers.

### BACKGROUND OF THE INVENTION

1. Field of the Invention

This invention relates to a printed circuit board for a speaker and the speaker with the printed circuit board, and a method of manufacturing the printed circuit board.

2. Description of the Related Art

Usually, a very small speaker is used for a small portable terminal, such as a portable telephone. The speaker includes a case, a diaphragm mounted on the case, a magnetic circuit received in the case and vibrating the diaphragm to generate a sound and a printed circuit board 100 (shown in FIG. 1) for supplying an audio current to the diaphragm.

The case has integrally an annular speaker receiving section and an extending portion extending from the speaker receiving section toward an outside thereof. The diaphragm has a voice coil for vibrating the diaphragm in cooperation with the magnetic circuit by supplying an audio current into the voice coil.

The printed circuit board 100 shown in FIG. 1 has an insulation base board 101 and a pair of conductive circuit patterns 102 to be connected with the voice coil. The conductive circuit pattern 102 is connected both with the voice coil and with an audio current source. The conductive circuit pattern 102 includes a base metal made of metal such as copper and formed on the base board 101, and a corrosion resisting plated layer made of a metal such as gold and formed on the base metal.

The printed circuit board 100, the conductive circuit pattern 102 of which is connected with the voice coil, is mounted on the extending portion of the case. Thereby, the conductive circuit pattern 102 is located at the extending portion. The printed circuit board 100 is to supply the audio current from the audio current source to the voice coil, that is, the diaphragm.

After the conductive circuit pattern 102 is formed on the base board material to be formed into the base board 101, by stamping, for example, punching the base board material, the base board 101 is made to be printed circuit board 100. Thus, the printed circuit board 100 is manufactured.

Objects to be Solved

The base board 100 of the printed circuit board is formed by punching the base board material on which the conductive circuit pattern 102 is formed. When the conductive circuit pattern 102 is punched, the base metal is exposed at an outer edge of the conductive circuit pattern 102, and corroded by aged deterioration. To eliminate punching the conductive circuit pattern for the above reason, it is required to provide a space Da (shown in FIG. 1) between the outer edge of the base board 101 formed by punching and the outer edge of the conductive circuit pattern 102.

Thereby, dimensions of an extending portion from the speaker receiving section is increased by the space between the outer edge of the conductive circuit pattern 102 and the outer edge of the base board 101. Thus, the printed circuit board 100 by prior art is enlarged and a speaker including the printed circuit board 100 is enlarged.

To overcome the above problem, one object of this invention is to provide a printed circuit board, which can be miniaturized, and a speaker including the printed circuit board, and a method of manufacturing the printed circuit board.

### SUMMARY OF THE INVENTION

How to Attain the Object

In order to attain the objects, a printed circuit board according to an aspect of this invention is specified by having an insulation base board and a conductive circuit pattern formed on a surface of the base board, the conductive circuit pattern being formed of a base metal laminated on the surface of the base board and a corrosion resisting plated layer covering the base metal, and arranging a partial outer edge of the base metal to overlap on a partial outer edge of the base board, and making the plated layer cover the partial outer edge of the base metal.

A speaker according to another aspect of this invention is specified by having a diaphragm, a magnetic circuit for generating sound to vibrate said diaphragm, and a printed circuit board as defined above, and specified by that the diaphragm includes a voice coil for vibrating the diaphragm by inputting the audio current into the voice coil disposed in the magnetic circuit, and the conductive circuit pattern of the printed circuit board is formed in a pair thereof on the base board, and each conductive circuit pattern respectively connects terminals of the voice coil with an audio current source for supplying the audio current.

A method of manufacturing a printed circuit board, which has an insulation base board, a base metal being laminated on a surface of the base board and a conductive circuit pattern with a corrosion resisting plated layer formed on the base metal for covering the base metal, is specified by having the steps of laminating the a base metal on the surface of a base board material which constitutes the base board, forming the base board by stamping the base board material, arranging a partial outer edge of the base metal to overlap on a partial outer edge of the base board, and forming the plated layer on the base metal.

Description of the Best Mode

One embodiment according to this invention will be described herein. A printed circuit board of the embodiment according to this invention can be miniaturized by overlapping a partial outer edge of the base metal of a conductive pattern plate and a partial outer edge of the base board to reduce a space between the outer edge of the base metal of the conductive circuit pattern and the outer edge of the base board.

The base metal of the printed circuit board is prevented from corrosion of the outer edge by covering the outer edge of the base metal of the conductive circuit pattern overlapping on the outer edge of the base board with the plated layer.

According to this invention, a speaker having the printed circuit board can be used.

According to this invention, a conductive circuit pattern can have a connecting portion for connecting with the audio current source, and at the connecting portion, an outer edge of the base metal can overlap on an outer edge of the base board.

According to this invention, a printed circuit board can be manufactured by laminating said a base metal on a base board material, punching the base board material, overlapping an outer edge of the base metal and an outer edge of the base board, and providing the plated layer on the base metal.

The above and other objects and features of this invention will become more apparent from the following description taken in conjunction with the accompanying drawings.

### BRIEF DESCRIPTION OF THE DRAWINGS

FIG. 1 is a plan view of a printed circuit board of a speaker by prior art;

FIG. 2A is a partially sectional plan view of a speaker of one embodiment according to the present invention;

FIG. 2B is a cross-sectional view taken along line 2B-2B in FIG. 2A;

FIG. 3A is a plan view of a printed circuit board of the speaker shown in FIG. 2A;

FIG. 3B is a cross-sectional view taken along line 3B-3B in FIG. 3A;

FIG. 4 is a cross-sectional view showing a part of a base board material, from which the base board of the printed circuit board shown in FIG. 3B is manufactured;

FIG. 5 is a cross-sectional view of the base board material shown in FIG. 4, on which a base metal for a conductive circuit pattern is formed;

FIG. 6 is a cross-sectional view of the base board material shown in FIG. 5, which is set between a set of dies of a punching machine;

FIG. 7 is a cross-sectional view of the base board, which is punched out from the base board material by the punching machine shown in FIG. 6;

FIG. 8 is a cross-sectional view of the base board, the base metal of which, shown in FIG. 7, is provided thereon with a first plated layer material; and

FIG. 9 is a cross-sectional view of the base board, the first plated layer of which, shown in FIG. 8, is provided thereon with a second plated layer.

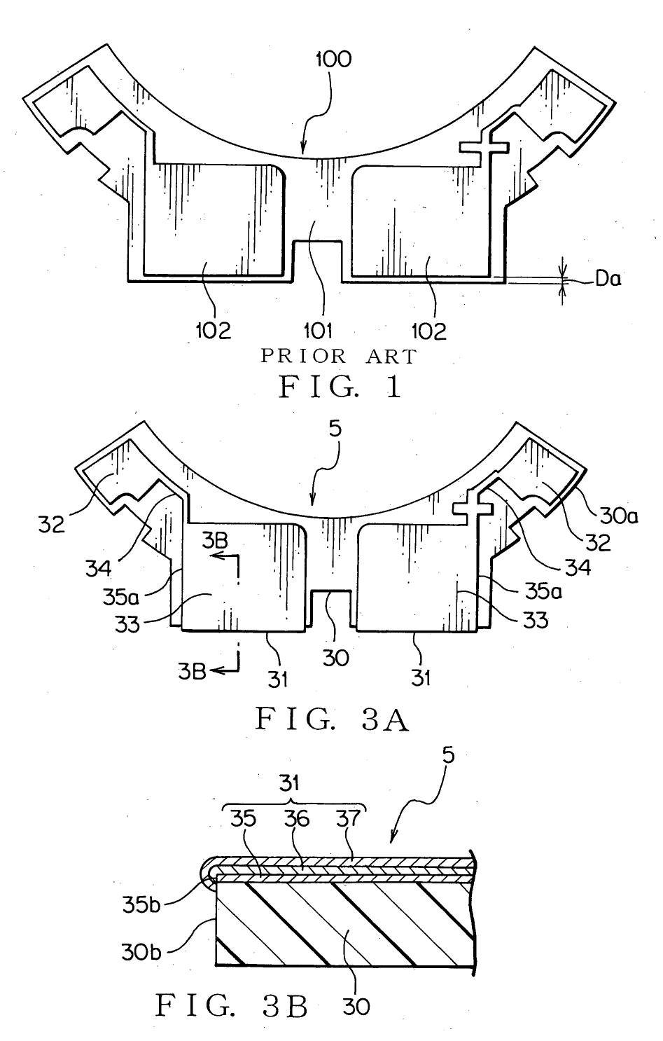

### DESCRIPTION OF EMBODIMENTS

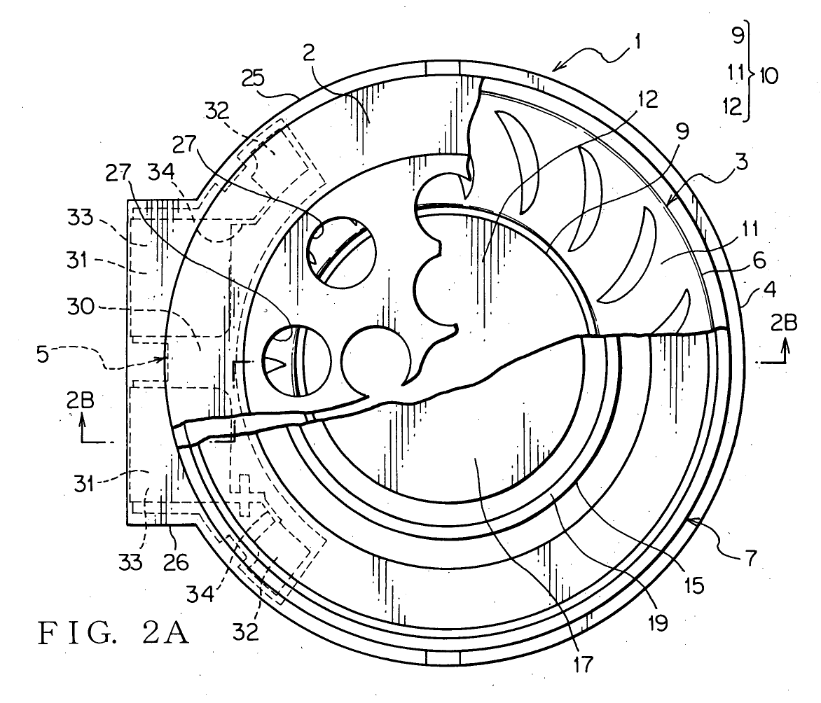

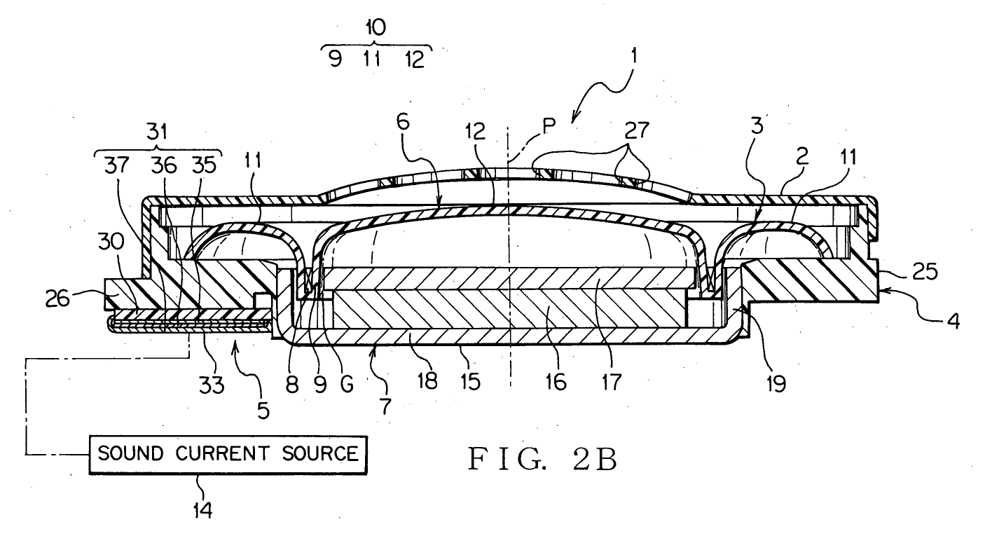

One embodiment according to the present invention will be described with reference to FIGS. 2A-9. A speaker 1 according to the embodiment according to the present invention structures a small portable terminal like a mobile phone to provide sound information to a user of the small portable terminal.

The speaker 1 includes a case 4, a cover 2, a speaker unit 3 and a printed circuit board 5 as shown in FIGS. 2A and 2B. The case 4 is, for example, made of a synthetic resin, and formed integrally with an annular ring portion 25 and an extending portion 26 extending from an outer edge of the ring portion 25 toward an outside thereof as shown in FIG. 2B. The ring portion 25 receives the speaker unit 3 inside thereof. The printed circuit board 5 is mounted on the extending portion 26.

The cover 2 is formed into a circular disk shape. An inner diameter of the cover 2 is equal to an outer diameter of the ring portion 25. The cover 2 is mounted on the case 4 so as to cover the ring portion 25. The case 4 and the cover 2 mounted on the case 4 cover the speaker unit 3. The cover 2 is provided with a plurality of holes 27 to allow transmission of sound generated by the speaker unit 3 toward an outside of the case 4, that is, to allow transmission of the sound to an outside of the speaker 1.

The speaker unit 3 has a diaphragm 6 and a magnetic circuit 7 to make diaphragm 6 generate sound by vibrating the diaphragm 6.

The diaphragm 6 is disposed between the cover 2 and the speaker unit 3. The diaphragm 6 includes a vibrating plate 10 and a voice coil 8. The vibrating plate 10 is formed into a thin-plate shape and provided integrally with an edge portion 11 formed annularly, a bobbin portion 9 formed cylindrically and a disk-shape vibrating portion 12.

An outer diameter of the edge portion 11 of the vibrating plate 10 is slightly smaller than an outer diameter of the cover 2. An inner diameter of the edge portion 11 is slightly larger than an outer diameter of a later-described yoke plate 17 of the magnet circuit 7 and slightly small than an inner diameter of a later-described cylindrical portion 19 of a yoke 15. An outer edge of the edge portion 11 is connected with a surface of the case 4 close to the cover 2. The edge portion 11 is disposed coaxially with the yoke 15 and the yoke plate 17, later-described, of the magnet circuit 7. The edge portion 11 allows the bobbin portion 9, that is, a vibrating plate 10 to vibrate along an axis P (shown with a long dashed short dashed line in FIG. 2B) and damps gradually vibration of the bobbin portion 9.

An inner diameter and an outer diameter of the bobbin portion 9 are approximately equal to the inner diameter of the edge portion 11. The inner diameter and an outer diameter of the bobbin portion 9 is larger than the outer diameter of the yoke plate 17 and smaller than the inner diameter of the cylindrical portion 19 of the yoke 15. One end of the bobbin portion 9 inserted into a later-described magnetic gap G continues to an inner edge of the edge portion 11 so as to be disposed coaxially with the edge portion 11. The bobbin portion 9 is disposed coaxially with the yoke 15 and the yoke plate 17. The one end of the bobbin portion 9 along the axis P is inserted into the magnetic gap G. The bobbin portion 9 is supported to move freely along the axis P of the yoke 15.

An outer diameter of the vibrating portion 12 is approximately equal to the inner diameter of the bobbin portion 9. An outer edge of the vibrating portion 12 continues to an inner edge of the bobbin portion 9 to be disposed coaxially with the bobbin portion 9.

In the vibrating plate 10 structured as mentioned above, the outer edge of the edge portion 11 is connected with the surface of the case 4. The vibrating plate 10 is mounted between the case 4 and the cover 2, thereby, the vibrating plate 10 is located between the yoke plate 17 of the magnetic circuit 7 and the cover 2.

A voice coil 8 is disposed between the outer edge of the bobbin portion 9 and the inner edge of the edge portion 11. The voice coil 8 is connected with an outer fringe of one end of the bobbin portion 9 disposed within the aforesaid magnetic gap G. The voice coil 8 is located coaxially both with the yoke 15 and the yoke plate 17 of the magnetic circuit 7 within the magnetic gap G of the magnetic circuit 7. The voice coil 8 is connected with a lead wire (not shown). The audio current from the audio current source 14 (shown in FIG. 2B) is supplied through the lead wire and printed circuit board 5 into the voice coil 8.

The magnetic circuit 7 includes the yoke 5 made of a magnetic material (paramagnetic material and ferromagnetic material), a magnet 16, and the yoke plate 17 made of the magnetic material (paramagnetic material and ferromagnetic material) and disposed coaxially with the yoke 15. The yoke 15 is provided integrally with a disk shape bottom plate 18 and the cylindrical portion 19 extending vertically from an outer edge of the bottom plate 18 and coaxially with the bottom plate 18.

The bottom plate 18 is provided so as to cover the ring portion 25 of the case 4. An outer diameter of the bottom plate 18 is larger than the outer diameter of the vibrating portion 12. The inner diameter of the cylindrical portion 19 is larger than the outer diameter of the bobbin portion 9. The bobbin portion 9 of the vibrating plate 10 is disposed so as to penetrate inside the cylindrical portion 19.

The yoke 15 is formed integrally with the case 4 so as to make the bottom plate 18 cover the cylindrical portion 25 of the case 4 by insert molding.

The magnet 16 is formed into a thick disk shape. The magnet 16 is one of a permanent magnet and a electromagnet activated by direct-current power 4 supply. An outer diameter of the magnet 16 is smaller than the inner diameter of the bobbin portion 9. The magnet 16 is stacked on the bottom plate 18 of the yoke 15 to penetrate into the bobbin potion 9 of the vibrating plate 10.

The yoke plate 17 is formed into a disk shape. The outer diameter of the yoke plate 17 is smaller than the inner diameter of the bobbin portion 9 of the vibrating plate 10. The yoke plate 17 is stacked on the magnet 16 so as to penetrate into the bobbin portion 9. The yoke 15, the magnet 16 and the yoke plate 17 are disposed coaxially with each other. An inner wall of the cylindrical portion 19 of the yoke 15 and an outer wall of the yoke plate 17 have a space therebetween.

The magnetic circuit 7, as structured above, is in inner magnet type. The magnetic circuit 7 forms the magnetic gap G between the inner wall of the cylindrical portion 19 of the yoke 15 and the outer wall of the yoke plate 17. The magnetic gap G generates a magnetic force for driving (vibrating) the vibrating plate 10 in cooperation with the aforesaid voice coil 8.

In the speaker unit 3 structured as mentioned above, by supplying the audio current into the voice coil 8, the voice coil 8 supported in the magnetic gap G vibrates along the aforesaid axis P corresponding to the audio current. Thereby, the voice coil bobbin 9 supporting the voice coil 8 vibrates together with the vibrating portion 12 of the vibrating plate 10 along the axis P, so that the vibrating portion 12 of the vibrating plate 10 generates sounds according to the audio current. Thus, the magnetic circuit 7 vibrates the vibrating plate 10, that is, the diaphragm 6, and generates sounds. The voice coil 8 vibrates the vibrating portion 12 of the vibrating plate 10 of the diaphragm 6 in cooperation with the magnetic circuit 7.

The printed circuit board 5, as shown in FIG. 3A, includes a base board 30 made of an insulating synthetic resin and a pair of conductive circuit patterns 31 formed on a surface of the base board 30. The base board 30 in a plan view is formed into a bow shape.

The pair of conductive circuit patterns 31 is disposed with a space to each other along lengthwise of the base board 30. Each conductive circuit portion 31 has integrally a lead wire connecting portion 32, a connecting portion 33 and a joining portion 34 for joining the connecting portions 32 and 33. The lead wire connecting portion 32 is disposed at en end of the base board 30 in a direction of lengthwise thereof. The aforesaid lead wire is connected with the lead wire connecting portion 32 by brazing with a solder or the like.

The connecting portion 33 is disposed at a middle area in the direction of lengthwise of the base board 30. The connecting portion 33 is connected with a lead wire, which is connected with the audio current source 14, by brazing with the solder or the like. Thus, the connecting portion 33 is connected with the audio current source 14. The audio current source 14 generates the audio current and supplies the audio current through the conductive circuit pattern 31 to the voice coil 8.

As shown in FIG. 3B, the conductive circuit pattern 31 is formed by stacking a base metal 35 and a first plated layer 36 in the order on the surface of the base board 30 among the lead wire connecting portion 32, the joining portion 34 and the connecting portion 33, that is, through the full length of the conductive circuit pattern 31. The base metal 35, made of an electrically conductive metal like a copper or a copper alloy and formed into a thin film shape (foil-like), is laminated on the surface of the base board 30. The base metal 35 is applied on the surface of the base board 30 with an adhesive.

The first plated layer 36, made of a corrosion resisting metal such as a nickel, is laminated on the surface of the base metal 35 so as to cover the base metal 35 together with the base board 30. At the connecting portion 33, a second plated layer 37 is laminated on a surface of the first plated layer 36. The second plated layer 37, made of a corrosion resisting metal like gold, is laminated on the surface of the first plated layer 36 so as to cover the first plated layer 36, that is, the base metal 35 together with the base board 30. The first plated layer 36 and the second plated layer 37 overlap on the plated layer in the present invention.

The base board 30 of the aforesaid printed circuit board 5 is formed into an arc shape, a center of which is at a center of the ring portion 25. The printed circuit board 5 is stacked on a surface of the extending portion 26, located at a rear side of the cover 2. The lead wire is connected with the lead wire connecting portion 32 of the printed circuit board 5, and the lead wire joined with the audio current source 14 is connected with the connecting portion 33 of the printed circuit board 5.

As shown in FIG. 3B, an outer edge 35b, which is a farthest part of the outer edge 35a (shown in FIG. 3A) of the base metal 35 at the connecting portion 33 of the printed circuit board 5 from the ring portion 25, overlaps on an outer edge 30b, which is a farthest part of the outer edge 30a (shown in FIG. 3A) of the base board 30 from the ring portion 25. In other words, the outer edges 30b, 35b are in the same surface. The farthest outer edge 35b of the outer edge 35a of the base metal 35 at the connecting portion 33 from the ring portion 25 is the part of the outer edge 35a of the base metal 35 described in the specification. The farthest outer edge 30b of the outer edge 30a of the base board 30 at the connecting portion 33 from the ring portion 25 is the part of the outer edge 30a of the base board 30 described in the specification.

The first plated layer 36 and the second plated layer 37 cover in the order the outer edge 35b of the base metal 35 at the connecting portion 33. Thus, the plated layers 36, 37 cover the outer edge 35b of the base metal 35, which overlaps on the outer edge 30b of the base board 30.

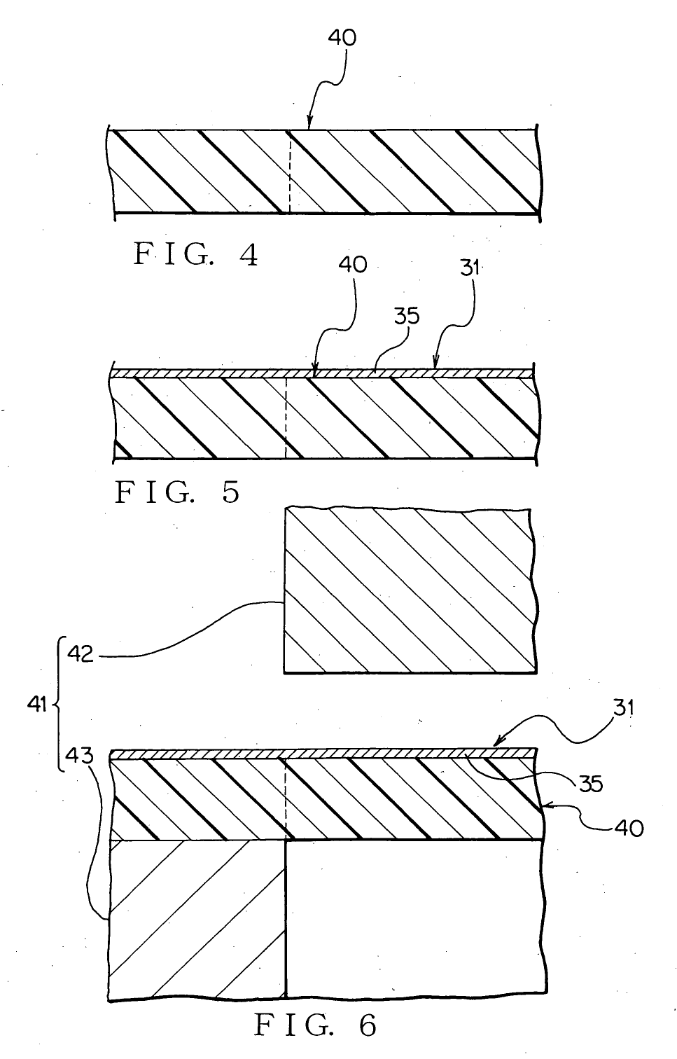

The printed circuit board 5 structured as mentioned above is manufactured as a flowing method. Firstly, a base board material 40 (shown in FIG. 4) made of an insulating synthetic resin for forming the base board 30 is set. A foil metal of copper or a copper alloy is applied on the base board material 40 with an adhesive. Ant-acid ink is printed on a surface of the foil metal to be formed into the conductive circuit pattern 31. A part of the foil metal, which is not printed with the ant-acid ink, is corroded with acid water solution for forming the conductive circuit pattern of the base metal 35 on the base board material 40. In this condition, the base metal 35 at the connecting portion 33 of the conductive circuit pattern 31 extends to an outside of the base board 30. Thus, the base metal 35 of the conductive circuit pattern 31 is laminated on the surface of the base board material 40.

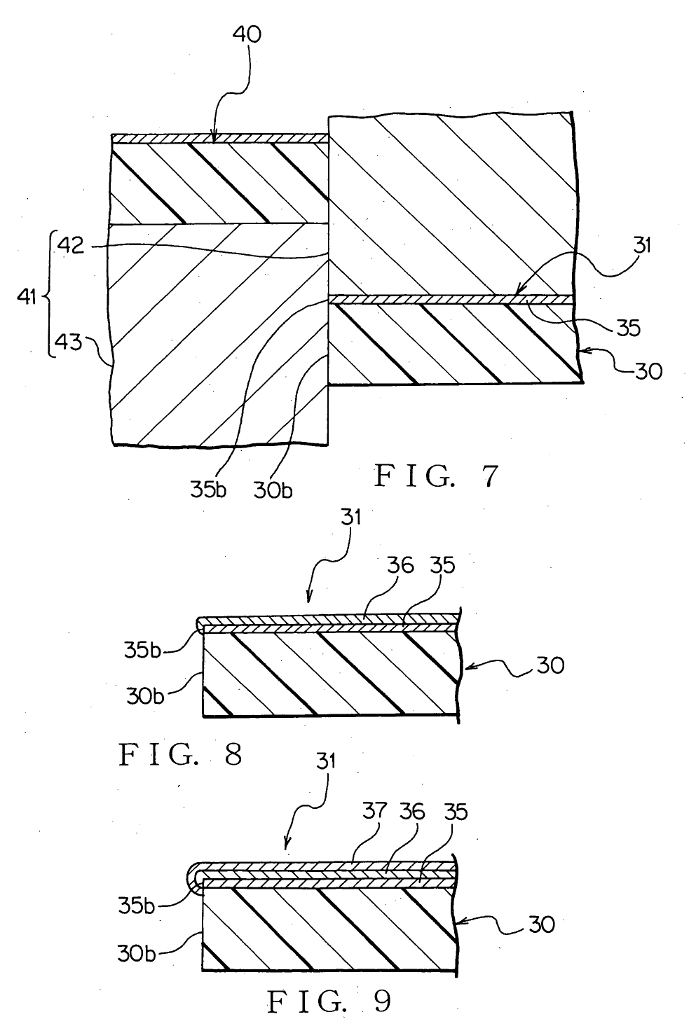

The base board material 40, on the surface of which the base metal 35 of the conductive circuit pattern 31 is formed, is set between a set of dies 42, 43 of a punching machine 41 for punching as shown in FIG. 6. By approaching the dies 42 and 43 to each other as shown in FIG. 7, and punching the base board material 40, the base board 30 is removed from the base board material 40 (the base board 30 is formed). Thereby, the outer edge 35b of the base metal 35 of the conductive circuit pattern 31 and the outer edge 30b of the base board 30 overlap on each other (arranged in the same plane). Thus, the base board 30, in which the outer edges 30b and 35b overlap on each other (arranged in the same plane) and the base metal 35 is formed, is manufactured.

Thereafter, the first plated layer 36 is formed on the base metal 35 as shown in FIG. 8. The first plated layer 36 covers also the outer edge 35b of the base metal 35. Furthermore, the second plated layer 37 is formed on the first plated layer 36 as shown in FIG. 9. The second plated layer 37 covers the first plated layer 36, that is, the outer edge 35b of the base metal 35. Thus, the printed circuit board 5 structured as mentioned above is manufactured.

According to this embodiment, the outer edge 35b of the base metal 35 of the conductive circuit pattern 31 overlaps on the outer edge 30b of the base board 30. In other words, the outer edge 35b of the base metal 35 of the conductive circuit pattern 31 and the outer edge 30b of the base board 30 are arranged in the same plane. Thereby, the space existing between the outer edge 35b of the base metal 35 of the conductive circuit pattern 31 and the outer edge 30b of the base board 30 is miniaturized so that the printed circuit board 5 can become smaller. The dimensions of an extending portion 26 from the ring portion 25 of the case 4 can be limited so that the speaker 1 can be miniaturized.

In the printed circuit board 5, the outer edge 35b of the base metal 35 of the conductive circuit pattern 31, overlapping on the outer edge 30b of the base board 30, is covered by the plated layers 36 and 37. Thereby, the base metal 35 can be prevented from corrosion started from the outer edge 35b of the base metal 35 of the conductive circuit pattern 31, overlapping on the outer edge 30b of the base board 30.

After laminating the base metal 35 on the base board material 40, the base metal 35 is formed into a required shape by punching the base board material 40. Thereby, the outer edge 35b of the base metal 35 and the outer edge 30b of the base board 30 can be securely overlapped on each other. Therefore, the printed circuit board 5 can be securely miniaturized.

The plated layers 36 and 37 are formed after punching the base board material 40 so that the outer edge 35b of the base metal 35 can be securely covered by the plated layers 36 and 37. Thereby, the base metal 35 can be prevented from corrosion started from the outer edge 35b of the base metal 35 of the conductive circuit pattern 31, overlapping on the outer edge 30b of the base board 30.

In the aforesaid embodiment, a method of forming the base board 30 is by punching. In this invention, various methods for forming the base board 30 can be applied.

According to the aforesaid embodiment, following printed circuit boards 5 and speakers 1 can be provided.

Type 1: A printed circuit board 5 includes an insulation base board 30 and a conductive circuit pattern 31 formed on a surface of the base board 30. The conductive circuit pattern 31 is formed of a base metal 35 laminated on the surface of the base board 31 and corrosion resisting plated layers 36 and 37 covering the base metal 35. A partial outer edge 35b of an outer edge 35a the base metal 35 overlaps on a partial outer edge 30b of an outer edge 30a of the base board 30, and the plated layers 36 and 37 cover the partial outer edge 35b of the base metal 35.

Type 2: A speaker includes a diaphragm 6, a magnetic circuit 7 for generating sound to vibrate the diaphragm 6, and a printed circuit board 5 as defined in type 1. The diaphragm 6 includes a voice coil 8 for vibrating the diaphragm 6 by inputting the audio current into the voice coil 8 in cooperation with the magnetic circuit 7. The conductive circuit pattern 31 is formed in a pair thereof on the base board 30. Each conductive circuit pattern 31 is respectively connected with both of the voice coil 8 and an audio current source 14 for supplying the audio current.

Type 3: In the speaker 1 according to Type 2, the conductive circuit pattern 31 has a connecting portion 33 for connecting with the audio current source 14, and the partial outer edge 35a of the base metal 35 at the connecting portion 33 overlaps on the partial outer edge 30b of the base board 30. The outer edge 35b of the base metal 35 overlapping on the outer edge 30b of the base board 30 is covered by the plated layers 36 and 37.

Type 4: A method of manufacturing a printed circuit board 5, which has an insulation base board 30, a base metal 35 being laminated on a surface of the base board 30 and a conductive circuit pattern 31 with corrosion resisting plated layers 36 and 37 formed on the base metal 35 for covering the base metal 35, includes the steps of laminating the base metal 35 on the surface of a base board material 40 to be formed into the base board 30, forming the base board 30 by punching the base board material 40, arranging a partial outer edge 35b of an outer edge 35a of the base metal 35 to overlap on a partial outer edge 30b of a outer edge 30a of the base board 30, and forming the plated layers 36 and 37 on the base metal 35.

The above mentioned embodiments are only typical examples according to the present invention, and the invention is not limited to the embodiments. Various modifications can be made without departing from the scope of the present invention. Incidentally, the contents of Japanese Patent Application No. 2004-246241 are hereby incorporated by reference.

What is claimed is:

1. A printed circuit board comprising:
an insulation base board; and
a conductive circuit pattern being formed on a surface of the base board,
whereby said conductive circuit pattern is formed of a base metal laminated on the surface of the base board and a corrosion resisting plated layer covering the base metal, and a partial outer edge of said base metal overlaps on a partial outer edge of said base board, and said plated layer covers the partial outer edge of the base metal.

2. A speaker comprising:
a diaphragm;
a magnetic circuit for generating sound to vibrate said diaphragm; and
a printed circuit board as defined in claim 1,
whereby said diaphragm has a voice coil for vibrating the diaphragm by inputting an audio current into said voice coil disposed in said magnetic circuit, wherein said conductive circuit pattern is formed in a pair on the base board, each conductive circuit pattern respectively connects terminals of the voice coil with an audio current source for supplying the audio current.

3. The speaker according to claim 2, wherein said conductive circuit pattern has a connecting portion for being connected with the audio current source, and the partial outer edge of the base metal at said connecting portion overlaps on the partial outer edge of the base board, wherein the outer edge of the base metal overlapping on the outer edge of the base board is covered by the plated layer.

4. A method of manufacturing a printed circuit board, which has an insulation base board, a base metal being laminated on a surface of the base board and a conductive circuit pattern with a corrosion resisting plated layer formed on said base metal for covering the base metal, comprising the steps of:
laminating said a base metal on the surface of a base board material which constitutes the base board;
forming the base board by stamping the base board material;
arranging a partial outer edge of the base metal to overlap on a partial outer edge of the base board; and
forming the plated layer on the base metal.
